(19) United States
(12) Patent Application Publication
(10) Pub. No.: US 2023/0244997 A1
(43) Pub. Date: Aug. 3, 2023

(54) MACHINE LEARNING PROCESSING FOR STUDENT JOURNEY MAPPING

(71) Applicant: Western Governors University, Salt Lake City, UT (US)

(72) Inventors: Adam COTA, Draper, UT (US); Carl BUSHNELL, Midvale, UT (US); Alan SMITH, Park City, UT (US)

(21) Appl. No.: 18/103,606

(22) Filed: Jan. 31, 2023

Related U.S. Application Data
(60) Provisional application No. 63/305,208, filed on Jan. 31, 2022.

(51) Int. Cl. G06N 20/00

(52) U.S. Cl. CPC G06N 20/00

(57) ABSTRACT

Generating a predictive mapping of an educational journey of a student. The method includes receiving, over a computer network, from a database of student records, unstructured data about a particular student of the educational institution. The unstructured data is normalized to classify the unstructured data consistent with a machine learning classification model to classify the unstructured data into a plurality of classifications. Based on the classifications of the unstructured data, A plurality of friction points that hinder a particular student's progress in the educational journey and a plurality of achievement points that promote the particular student's progress in the educational journey are identified. Using the friction points and achievement points, prediction information is generated of the particular student's progress in the educational journey. The prediction information is consistent with a machine learning prediction model. The prediction information is transmitted over the computer network to an administrator machine.

### CROSS-REFERENCE TO RELATED APPLICATIONS

This application claims the benefit of and priority to U.S. Provisional patent application Ser. No. 63/305,208 filed on Jan. 31, 2022 and entitled “Natural Language Processing For Student Journey Mapping,” and which application is expressly incorporated herein by reference in its entirety.

### BACKGROUND

### Background and Relevant Art

Typical educational institutions include hundreds, thousands, or even tens of thousands of students at the educational institution. Accordingly, massive amounts of data are generated regarding the various students at the educational institution. Using the data in unconventional, but useful ways can be problematic. For example, if a specific piece of information is desired, a specific record can be consulted to identify the specific piece of information. For example, if there is a desire to identify grades of particular student, a database containing structured data with grade data correlated to the student can be consulted. However, the massive amounts of data may include unstructured data from which it is more difficult to obtain useful information. For example, such unstructured data may include mentor notes where a mentor describes in a free-form format conversations with the student and/or observations about the student. It can be difficult to gather specific pieces of information from this unstructured data without performing a time intensive action of simply reading through the notes until the desired information is obtained.

Additionally, in educational institutions it should be an important goal to facilitate student development and progress. Such progress may be virtually impossible to document in a comprehensive fashion in view of the massive amounts of data for each student multiplied over the hundreds, thousands, or even tens of thousands of students at the educational institution. This is further exacerbated by issues with respect to unstructured data as discussed above. In particular, identifying relevant data points using unstructured data is difficult and non-uniform depending on how the relevant data is identified and/or characterized.

Thus, it would be useful to implement systems capable of standardizing data and using such data to map student journeys.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method of generating a predictive mapping of an educational journey of a student at an education institution. The method includes receiving, over a computer network, from a database of student records, unstructured data about a particular student of the educational institution. The unstructured data is normalized to classify the unstructured data consistent with a machine learning classification model to classify the unstructured data into a plurality of classifications. Based on the classifications of the unstructured data, A plurality of friction points that hinder a particular student's progress in the educational journey and a plurality of achievement points that promote the particular student's progress in the educational journey are identified. Using the friction points and achievement points, prediction information is generated of the particular student's progress in the educational journey. The prediction information is consistent with a machine learning prediction model. The prediction information is transmitted over the computer network to an administrator machine.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a system for providing predictive journey mapping information;

FIG. 2 illustrates graphical information with respect to quantities of data being processed in a big data processing analysis to predict journey mapping information;

FIG. 3 illustrates an example journey map comprising a predicted cause for student withdrawal; and

FIG. 4 illustrates a method of generating a predictive mapping.

### DETAILED DESCRIPTION

Students at educational institutions may find points during their education that are difficult, referred to herein as friction points. Similarly, students at educational institutions may find points during their education where the students are successful and thus gain momentum. These points are referred to herein as achievement points. Embodiments illustrated herein are able to classify, identify, and quantify friction points and achievement points in a fashion that allows systems to predict a student's educational journey. These actions of classifying, identifying, quantifying, and predicting can be facilitated using computing systems with appropriate artificial intelligence models.

Further, the computing systems include network interfaces which allow the computing systems to be interconnected in a fashion that allows data to be obtained from various remote databases storing student information and other information that can be used as input for the models and/or data to refine and/or train the models. Further, network communication hardware on the computing systems allows prediction information to be provided to other appropriate systems where the prediction information can be accessed by appropriate educational institution personnel. For example, information may be transmitted over a network to a mentor informing the mentor that a particular student is likely to withdraw from the educational institution. In some embodiments, the prediction information may also provide a prediction of actions that would make the particular student less likely to withdraw from the educational institution. Using the computing functionality described herein, appropriate actions can then be taken to support the particular student. Additional details are now illustrated.

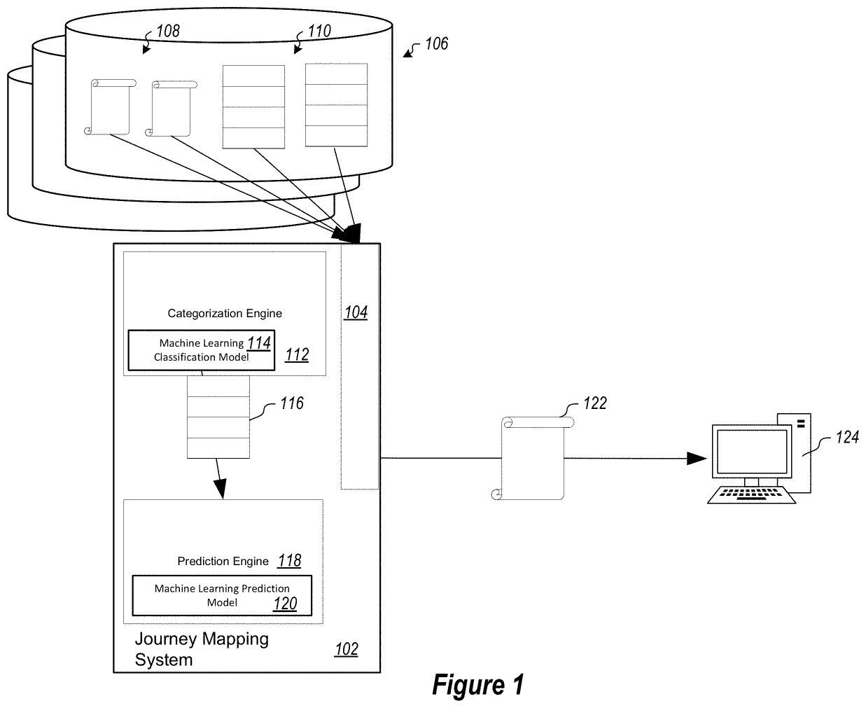

Referring now to FIG. 1, an example is illustrated. FIG. 1 illustrates a journey mapping system 102. The journey mapping system 102 includes functionality for analyzing data to generate prediction information of a student's progress in an educational journey. The journey mapping system 102 includes network hardware 104. For example, the network hardware may include various network interface controllers such as wired or wireless network hardware. For example, such network hardware may be ethernet hardware or other hardware suitable for networking with other devices.

In the example illustrated in FIG. 1, the network hardware 104 is connected to a plurality of databases 106. While the databases 106 are illustrated together, it should be appreciated that the databases may be located in a number of different places, and indeed may be under the control of different entities. For example some databases may be owned and operated by the education institution on site at the educational institution. Other databases may be part of cloud services subscribed to by the educational institution. For example, an institution may store data using services provided by Salesforce Inc., of San Francisco, Calif. In other examples, databases may be operated by entities unaffiliated, or with only tangential affiliation with the education institution. For example, the databases may be social media databases, governmental body databases, etc.

The databases 106 may include unstructured data 108 and/or structured data 110. Unstructured data is data which includes multiple concepts, but the concepts are not organized into a predefined data model distinguishing the concepts as such. That is, while unstructured data may be stored in a data structure, a given set of data has multiple distinguishable concepts that are not structured in a fashion that separates the concepts according to the organization of the data structure. For example, free-form sentences and paragraphs are typically considered to be unstructured data. A given sentence may include multiple concepts in the single sentence. Nonetheless, the sentence is stored without distinguishing the concepts using the structure of the data structure.

In contrast, structured data is data that is organized, by concept, in a data structure according to a schema of the data structure. Typically, each concept in the data is placed in a location and in a fashion in the data structure as defined by the data structure schema. Additionally, each concept has a value. Thus for example, a data structure may have an organization that contemplates different color values at a particular location in the data structure. Valid color values might be red, orange, yellow, green, blue, indigo, violet, and so forth. Thus, while it is a relatively simple operation for computing systems to identify relevant data values in structured data, the same is not true with unstructured data.

It is even more difficult for a human user analyzing the unstructured data to accurately and consistently identify and evaluate relevant concepts in the unstructured data. It is even more problematic when multiple different human users each attempt to manually analyze concepts in unstructured data.

Thus, the journey mapping system 102 of FIG. 1 includes a categorization engine 112. The categorization engine 112 is able to consume the unstructured data 108 to categorize the unstructured data 108. In particular, the categorization engine 112 is able to normalize the unstructured data 108 to classify the unstructured data 108 consistent with a machine learning model 114. This is done to classify the unstructured data 108 into a plurality of classifications. The machine learning model 114 may be a model created and/or based on any one of a number of different machine learning concepts. For example, the classification model 114 may be based on a supervised machine learning model, an unsupervised machine learning model, or appropriate machine learning model. The classification engine 112 may use various types machine learning, such as natural language processing, regression analysis, etc.

Various examples of unstructured data in the unstructured data 108 are now illustrated. In some embodiments, the unstructured data may include mentor notes created by a mentor and stored in one of the databases 106. For example, a mentor may meet with a student on a particular basis to evaluate a student's progress in an educational journey. The mentor may discuss and document friction points (times in a student's educational journey that cause difficulty for the student), achievement points (times in a student's educational journey that encourage student progress and success) and other issues. Typically, the documentation is simply in the form of sentences and paragraphs documenting the mentor's observations of the student and discussions with the student.

Another example of unstructured data that may be relevant includes email interactions. For example, a student may use an educational institution email account to send emails to mentors, instructors, other students, or others. These email interactions are typically in the form of sentences and paragraphs which include multiple concepts in an unstructured fashion. Another example of unstructured data that may be relevant includes assessment responses. In particular, assessments (e.g., tests and homework assignments) may require the student to enter free-form data. Again, the data included in assessment responses may include multiple concepts in free-form sentences and paragraphs. Another example of unstructured data that may be relevant is instructor notes about a student or group of students to which the student belongs. Another example of unstructured data that may be relevant includes social media posts by a student or about a student. Another example of unstructured data that may be relevant includes course survey responses including responses provided by the student and/or responses provided by other students in a course in which the student is, has been, or will be enrolled. Another example of unstructured data that may be relevant includes personality test responses by the student. Another example of unstructured data that may be relevant includes aptitude test responses by the student.

Returning once again to FIG. 1, this unstructured data 108 is provided through the network hardware 104 to the categorization engine 112 where it is categorized according to a machine learning classification model 114.

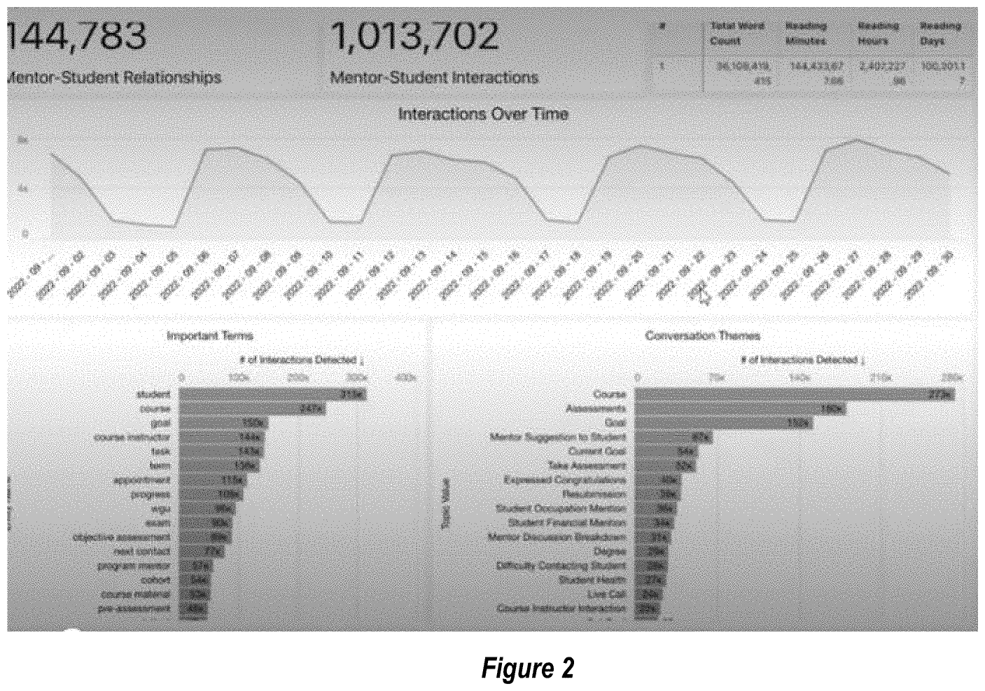

FIG. 2 illustrates an actual example of the kinds of classifications and operations that have been performed for a particular educational institution. Note that FIG. 2 illustrates an example where 144,783 mentor-student relationships have existed. In this example, over 1 million mentor-student interactions have occurred to create mentor notes. In the example illustrated over 36 billion words were generated. Just to read the words generated without performing any categorization whatsoever, over 2 million hours would be needed. Thus, one can understand the difficulty of generating useful information from unstructured data at an educational institution. Note, that the data illustrated in FIG. 2 is only for mentor notes and that the quantities of data become much larger when multiple different sources of unstructured data are considered. As illustrated in FIG. 2, the categorization engine 112 may identify important terms as well as conversation themes. In the example illustrated in FIG. 2, the important terms illustrated include student, course, goal, course instructor, task, term, appointment, progress, objective assessment, contact, program mentor, cohort, course material, preassessment, etc. Conversation themes include course, assessments, goal, mentor suggestion to student, current goal, take assessment, expressed congratulations, resubmission, student occupation mention, student financial mention, mentor discussion breakdown, degree, difficulty contacting student, student health, live call, course instructor, etc.

Note that FIG. 1 also illustrates that structured data 110 is provided to the network hardware 104 into the categorization engine of the journey mapping system 102. Structured data 110 may be easier to classify and indeed in some embodiments is pre-classified due to the nature of the data. Structured data may be for example data structures having assigned grades, financial aid status, transferred credits, etc.

The categorization engine 112, using the machine learning classification model 114, is able to classify data from unstructured data 108 and/or structured data 110 to identify friction points which hinder a student's progress and achievement points which facilitate a student's progress in an educational journey.

Each unstructured data source may surface different types of unique insights. For instance, Salesforce and email may surface insights about financial aid friction points, while data from a learning management system may surface insights about technology failures or learning difficulties. Given that the relative volume of data from these data sources may also vary, various steps are taken, such as maintaining separation of data sources for model training, to ensure that unique insights from smaller data sources are surfaced and not washed away by larger data sources.

FIG. 1 illustrates that once data has been categorized the categorized data 116 can be sent to a prediction engine 118. The prediction engine 118 includes a machine learning prediction model 120 which may be generated using various machine learning techniques such as supervised learning, unsupervised learning, etc. The prediction engine 118 is able to use the friction points and achievement points to generate prediction information for a particular student. That is, the prediction engine 118 can generate prediction information regarding a particular student's progress in an educational journey where the prediction information is consistent with the machine learning prediction model 120. Prediction information in this context includes a prediction of the students predicted future actions and/or a prediction of the students predicted outcomes.

For example, the prediction engine 118 may predict that the particular student will withdraw from the educational institution within a predetermined time. Alternatively, or additionally, the prediction engine 118 may predict that a student will receive non-passing grades. The prediction may be for a particular course. Alternatively, or additionally, the prediction may predict a percentage of courses for which the student will not receive a passing grade. Alternatively, or additionally, the prediction engine may predict that a student will successfully complete coursework. In some embodiments, the prediction engine may predict a timeframe in which a student is expected to complete coursework and/or an entire field of study.

The prediction engine 118 may further be configured to generate reasons for a predicted event. For example, the prediction engine 118 may predict that a student will withdraw from an educational institution due to financial reasons. Alternatively, or additionally, the prediction engine 118 may predict that a student will withdraw from an educational institution due to family reasons. Various other reasons may be identified by the prediction engine 118. In some embodiments, the prediction engine 118 may identify multiple reasons that an event is predicted to occur, and can rank the reasons. Such ranking for example may be simply a numerical ranking from most significant to least significant. In an alternative example, the predicted set of reasons can be ranked where each reason is assigned a percentage representing significance of that reason for the predicted event occurring.

Note that in some embodiments, the prediction information may simply be a predicted reason for an event that has already occurred. For example in some embodiments, the prediction information may predict why a student that has already withdrawn withdrew.

The prediction engine 118 and machine learning prediction model 120 may be implemented and/or trained in a number of different fashions. For example, in some embodiments, the prediction model may be trained using past data for other students with respect to friction points and achievement points and actual outcomes. The prediction model 120 may be trained using studies and study data. In some embodiments, the prediction model 120 may use root cause analysis to predict prediction information.

FIG. 1 further illustrates that the prediction information 122 produced by the prediction engine 118 is transmitted to an administrator machine 124. In particular, the prediction information 122 is transmitted using the network hardware 104 to the administrator machine 124. The administrator machine 124 may be accessible to a mentor, educational institution staff, the student themselves, or other individuals. This allows for corrective action to be taken to avoid the predicted event. Alternatively, if the predicted event is a positive prediction, this information can be provided to the student as encouragement to the student to complete their educational journey.

Note that in some embodiments, the prediction engine 118 in the machine learning prediction model 120 may further include functionality for predicting actions or events that may change the nature of the prediction. For example, such prediction of actions may include encouraging a student to drop a particular class, enroll in a particular class, apply for certain financial aid, establish regular meetings with a mentor, apply for certain government assistance programs, engage a tutor, etc. This information can be included in the prediction information 122 that is provided to the administrator machine 124.

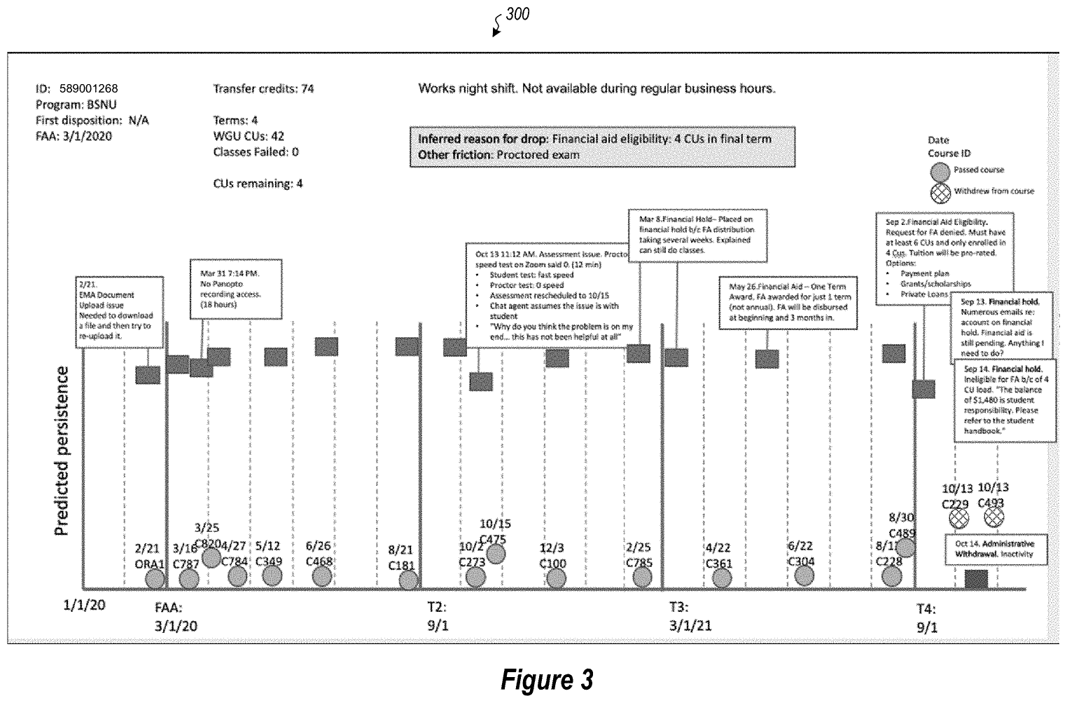

In some embodiments, the prediction information 122 may be provided as part of a journey map which includes a selection of friction points and achievement points in a student's educational journey. An example of this is illustrated in FIG. 3 which illustrates an example journey map 300 documenting various events in a student's educational journey. In journey map 300, each of the text boxes signaling friction points may contain a great deal of text to describe the issue in full. This context and level of detail is useful in understanding and ability to resolve friction points. Friction points are displayed in the user interface in a fashion that is clear for ease of understanding while also allowing access to further information and additional context.

In some embodiments, the journey map 300 may be automatically generated based on the categorized data 116 provided to the prediction engine 118. In particular, the prediction engine 118 can rank friction points and achievement points included in the categorized data 116 in context with a predicted event. That is, the prediction engine 118 can determine a magnitude of correlation between a friction point and/or achievement point and predictions in the prediction information 122. In some embodiments, when a friction point and/or achievement point exceeds a predetermined threshold of correlation, then data related to the friction point and/or achievement point will be included in the journey map 300. Alternatively, or additionally, a top predetermined number of friction points and/or achievement points by a correlation factor to a prediction are included in the journey map 300.

Data included in the journey map 300 may be generated in various different ways. For example, in some embodiments, unstructured data from the unstructured data 108 used to identify friction points and achievement points can be included directly in the journey map. Thus, for example, relevant portions of a mentor's actual notes will be included in the journey map. This can be facilitated by the categorization engine 112 which can extract the phrases that were primarily used above other phrases to categorize the unstructured data 108 into either a friction point or an achievement point.

In an alternative and/or additional example, some entries in the journey map 300 may be included using standardized language. Thus, for example, rather than directly including mentor notes as written by the mentor in the journey map 300, standardized phrases correlated to the concepts identified by the categorization engine 112 may be included in the journey map.

When structured data is used to identify a friction point and/or achievement point, standardized phrases can be used in the journey map 300 to provide a plain language description of the friction point and/or achievement point.

While variances in key metrics can be identified and located through the examination of mix shift and rate changes (e.g., changes in drop rates), deep contextual understanding of the student journey is used to further identify affected populations, eliminate competing hypotheses, and solve for root cause with appropriate interventions.

Friction point trends may be used at different levels of analysis. As an educational institution works to address and eliminate friction points for students, changes in those friction points are monitored over time to track progress, e.g., to what extent certain friction points are increasing or decreasing and for which students. Tracking friction points can be done at the university, college, undergrad/grad, and program levels.

When done at scale, machine learning processing of the educational institution's unstructured data generates inputs back into journey maps (e.g., newly discovered friction points, trends in friction points) that continually improve and enhance their actionability and value. Embodiments can also produce data points that can be included in the educational institution's predictive modeling to improve model accuracy and allow the institution to proactively address friction points before they result in delays or barriers to student degree completion.

Note that prediction information provided to the administer machine 124 can be aggregated on an individual student basis or on a collective aggregated basis. Various embodiments may include user interface elements to allow for viewing data in various fashions. In some embodiment, user interface elements and computing functionality may allow for filtering by program/college level, learner profile groups, configurable learner profile groups. Some embodiments may include functionality for displaying a condensed, most frequent/significant friction points and/or achievement points list. Embodiments may include a user interface that displays condensed key statistical information of aggregate friction point analysis. Some embodiments may generate, using the prediction engine 118, and display a training/calibration plan based on friction point and achievement point findings. These plans may have a faculty focus. Embodiments may include functionality for identifying and surfacing in a user interface comparisons of student outcomes such as when comparing one group of students to another. Embodiments may include functionality for identifying and surfacing in a user interface lists of students that experience the most frequent/significant friction point and/or achievement point types.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

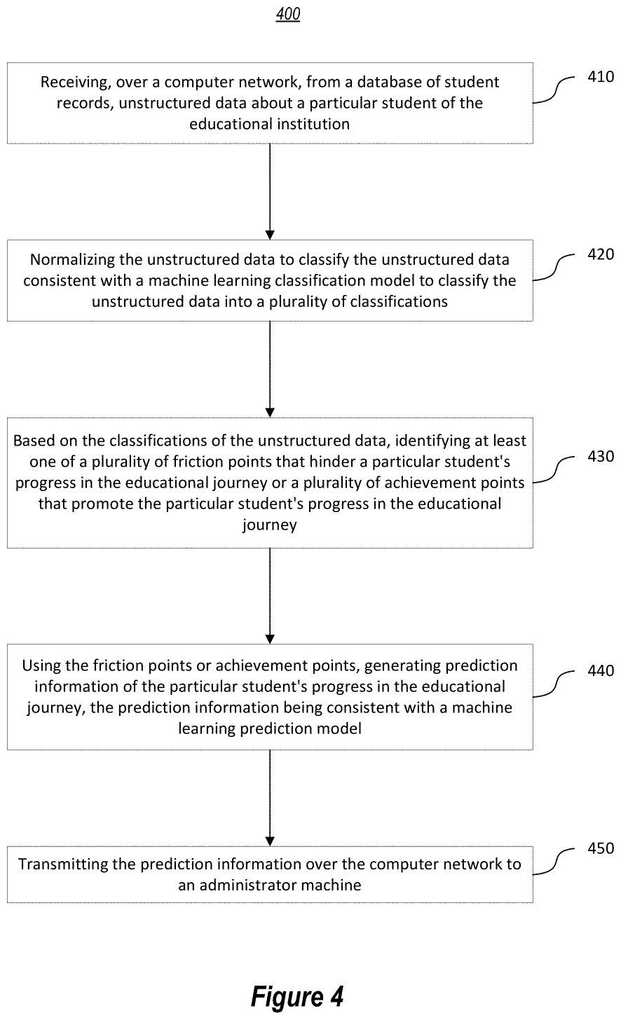

Referring now to FIG. 4, a method 400 is illustrated.

The method 400 includes acts for generating a predictive mapping of an educational journey of a student at an education institution. The method 400 includes receiving, over a computer network, from a database of student records, unstructured data about a particular student of the educational institution (act 410).

The method 400 further includes normalizing the unstructured data to classify the unstructured data consistent with a machine learning classification model to classify the unstructured data into a plurality of classifications (act 420).

Based on the classifications of the unstructured data, the method 400 further includes identifying at least one of a plurality of friction points that hinder a particular student's progress in the educational journey or a plurality of achievement points that promote the particular student's progress in the educational journey (act 430).

The method 400 further includes using the friction points and achievement points, generating prediction information of the particular student's progress in the educational journey, the prediction information being consistent with a machine learning prediction model (act 440).

The method 400 further includes transmitting the prediction information over the computer network to an administrator machine (act 450).

The method 400 may be practiced where the prediction information is included a journey map comprising an indication of a plurality of the friction points or a plurality of the achievement points, including summary information for the plurality of the friction points or the plurality of the achievement points.

The method 400 may be practiced where the unstructured data comprises at least one of mentor notes, email interactions, assessment responses, instructor notes, social media posts, course surveys, personality test responses, or aptitude test responses.

The method 400 may further include receiving over the computer network, structured data. In some such embodiments, the structured data is used in the machine learning prediction model in generating the prediction information of the particular student's progress in the educational journey.

In some embodiments, the structured data and unstructured data comprises at least one of mentor notes, email interactions, helpdesk tickets, program information, assigned grades, discipline write ups, assessment responses, financial aid status, transferred credits, academic resource interactions, instructor notes, marketing data, social media posts, governmental body reports and/or studies, course survey responses, personality test responses, or aptitude test responses.

In some embodiments, structured data is used to generate friction points and achievement points.

In some embodiments, structured data is used to refine the machine learning prediction model.

In some embodiments, the unstructured data, based on the classifications, is used to refine the machine learning prediction model. For example, government studies and/or reports may be used to refine the machine learning prediction model.

In some embodiments, the machine learning classification model comprises a natural language processing model.

In some embodiments, the machine learning prediction model comprises a root cause analysis model.

The method 400 may further include using the machine learning prediction model to generate intervention output suggesting action to alter the generated prediction information; and transmitting the intervention output over the computer network to the administrator machine. Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

With regard to all of the foregoing, it will be appreciated that the disclosed embodiments may include or be practiced by or implemented by a computer system which is configured with one or more hardware processors and computer storage that stores computer-executable instructions that, when executed by one or more processors, cause various functions to be performed, such as the acts recited above.

Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other hardware storage devices which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of generating a predictive mapping of an educational journey of a student at an education institution, the method comprising:
receiving, over a computer network, from a database of student records, unstructured data about a particular student of the educational institution;
normalizing the unstructured data to classify the unstructured data consistent with a machine learning classification model to classify the unstructured data into a plurality of classifications;
based on the classifications of the unstructured data, identifying at least one of a plurality of friction points that hinder a particular student's progress in the educational journey or a plurality of achievement points that promote the particular student's progress in the educational journey;
using the friction points or achievement points, generating prediction information of the particular student's progress in the educational journey, the prediction information being consistent with a machine learning prediction model; and
transmitting the prediction information over the computer network to an administrator machine.

2. The method of claim 1, wherein the prediction information is included a journey map comprising an indication of a plurality of the friction points or a plurality of the achievement points, including summary information for the plurality of the friction points or the plurality of the achievement points.

3. The method of claim 1, wherein the unstructured data comprises at least one of mentor notes, email interactions, assessment responses, instructor notes, social media posts, course surveys, personality test responses, or aptitude test responses.

4. The method of claim 1, further comprising:
receiving over the computer network, structured data; and
wherein the structured data is used in the machine learning prediction model in generating the prediction information of the particular student's progress in the educational journey.

5. The method of claim 4, wherein the structured data and unstructured data comprises at least one of mentor notes, email interactions, helpdesk tickets, program information, assigned grades, discipline write ups, assessment responses, financial aid status, transferred credits, academic resource interactions, instructor notes, marketing data, social media posts, governmental body reports, course survey responses, personality test responses, or aptitude test responses.

6. The method of claim 4, wherein the structured data is used to generate friction points or achievement points.

7. The method of claim 4, wherein the structured data is used to refine the machine learning prediction model.

8. The method of claim 1, wherein the unstructured data, based on the classifications, is used to refine the machine learning prediction model.

9. The method of claim 1, wherein the machine learning classification model comprises a natural language processing model.

10. The method of claim 1, wherein the machine learning prediction model comprises a root cause analysis model.

11. The method of claim 1, further comprising:
using the machine learning prediction model to generate intervention output suggesting action to alter the generated prediction information; and
transmitting the intervention output over the computer network to the administrator machine.

12. A computing system comprising:
one or more processors; and
one or more computer-readable media having stored thereon instructions that are executable by the one or more processors;
network hardware configured to receive, over a computer network, from a database of student records, unstructured data about a particular student of an educational institution;
a categorization engine comprising a machine learning classification model, implemented by the one or more processors and the instructions, configured to normalize the unstructured data to classify the unstructured data consistent with the machine learning classification model to classify the unstructured data into a plurality of classifications and based on the classifications of the unstructured data, identify at least one of a plurality of friction points that hinder a particular student's progress in the educational journey or a plurality of achievement points that promote the particular student's progress in the educational journey;
a prediction engine comprising a machine learning prediction model, implemented by the one or more processors and the instructions, configured to, using the friction points or achievement points, generate prediction information of the particular student's progress in the educational journey, the prediction information being consistent with a machine learning prediction model; and
wherein the network hardware is configured to transmit the prediction information over the computer network to an administrator machine.

13. The computing system of claim 12, wherein the prediction information is included a journey map comprising an indication of a plurality of the friction points or a plurality of the achievement points, including summary information for the plurality of the friction points or the plurality of the achievement points.

14. The computing system of claim 12, wherein the unstructured data comprises at least one of mentor notes, email interactions, assessment responses, instructor notes, social media posts, course surveys, personality test responses, or aptitude test responses.

15. The computing system of claim 12, wherein the unstructured data, based on the classifications, is used to refine the machine learning prediction model.

16. The computing system of claim 12, wherein the machine learning classification model comprises a natural language processing model.

17. The computing system of claim 12, wherein the machine learning prediction model comprises a root cause analysis model.

18. The computing system of claim 12, wherein the machine learning prediction model is configured generate intervention output suggesting action to alter the generated prediction information.

19. A computing system comprising
one or more processors; and
one or more computer-readable media having stored thereon instructions that are executable by the one or more processors to configure the computer system to perform predictive journey mapping, including instructions that are executable to configure the computer system to perform at least the following:
receive, over a computer network, from a database of student records, unstructured data about a particular student of an educational institution;
normalizing the unstructured data to classify the unstructured data consistent with a machine learning classification model to classify the unstructured data into a plurality of classifications;
based on the classifications of the unstructured data, identify at least one of a plurality of friction points that hinder a particular student's progress in the educational journey or a plurality of achievement points that promote the particular student's progress in the educational journey;
using the friction points or achievement points, generate prediction information of the particular student's progress in the educational journey, the prediction information being consistent with a machine learning prediction model; and
transmit the prediction information over the computer network to an administrator machine.

20. The computing system of claim 19, wherein the prediction information is included a journey map comprising an indication of a plurality of the friction points or a plurality of the achievement points, including summary information for the plurality of the friction points or the plurality of the achievement points.
